(19) United States
(12) Patent Application Publication
(10) Pub. No.: US 2025/0224608 A1
(43) Pub. Date: Jul. 10, 2025

(54) HEATING ENHANCED STRUCTURE FOR PHOTO-SENSITIVE SENSING DEVICE WITH AUTOMATIC FOREIGN OBJECT REMOVAL

(71) Applicant: H.P.B. OPTOELECTRONICS CO., LTD., Taichung City (TW)

(72) Inventors: Hsuan-Yueh Hsu, Taichung City (TW); Yung-Chih Chen, Taichung City (TW)

(21) Appl. No.: 19/007,807

(22) Filed: Jan. 2, 2025

(30) Foreign Application Priority Data
Jan. 6, 2024 (TW) 113200224

(51) Int. Cl. G02B 27/00; B08B 7/00; B08B 7/02

(52) U.S. Cl. CPC G02B 27/0006; B08B 7/0071; B08B 7/02

(57) ABSTRACT

The present invention relates to a heating enhanced structure for a photo-sensitive sensing device with automatic foreign object removal, particularly involving the use of a structure made of flexible and rigid materials for sealing the photo-sensitive sensing device and transmitting vibrations generated by piezoelectric elements. The photo-sensitive sensing device includes a housing, a transparent protective cover, a photo sensor, a lens module, a sealing material with flexibility and rigidity, and a piezoelectric element. The device is further equipped with a heating element to optimize the automatic foreign object removal function, reduce the frequency of piezoelectric element usage, thereby lowering power consumption, extending the operational lifespan, and improving the efficiency of removing small liquid droplets.

### CROSS-REFERENCE TO RELATED APPLICATION

This application claims the priority of Taiwanese patent application No. 113200224, filed on Jan. 6, 2024, which is incorporated herewith by reference.

### BACKGROUND OF THE INVENTION

### 1. Field of the Invention

The present invention relates to a heating enhanced structure for a photo-sensitive sensing device with automatic foreign object removal, particularly relates to an optical detection system, which uses a structure made of flexible and rigid materials to seal the photo-sensitive sensing device and transmit vibrations generated by piezoelectric elements, and equipped with heating elements, thereby optimizing the automatic foreign object removal function.

### 2. The Prior Arts

Optical detection system is a system equipped with a photo-sensitive sensing device that collects optical information from the external environment through a light-transmissive observation window, the optical information is converted into electrical signals by a photo sensor, which are then processed by a processor to generate set corresponding responses. The system includes an optical detection device for light-receiving alone, such as video camera, camera, and partial passive photo sensors, and also includes a light-emitting device that actively project light, such as structured light devices, time of flight (ToF) cameras, and optical radar systems. However, in outdoor or complex environments full of foreign substances, the photo-sensitive sensing device is prone to being affected by contamination of the observation window caused by the adhesion of foreign substances. For example, raindrops (water droplets), snow, frost, mud, and other foreign substances may adhere to the observation window, which obstructs, refracts, or reflects the incident light, thereby affecting the light signals received by the photo sensor, leading to signal deterioration or degradation.

In this regard, many developers have proposed corresponding cleaning solutions. U.S. Pat. No. 11,002,954 B2 discloses an image capturing apparatus including a cleaning device, in which the surface of the translucent body can be cleaned by vibrating the translucent body with a vibrator. However, the vibrator must have a barrel-shaped structure (e.g., first and second cylindrical members) to provide a space for vibration. Such vibration device makes the structure of the optical detection system (which is camera in this disclosure) become larger and more complicated. The inventor has also proposed U.S. Pat. No. 11,489,988 B2, which discloses a method for removing foreign substances from a camera system, and an instant clear view system (ICVS), wherein in the ICVS, a piezoelectric component is provided on a transparent cover of a camera device, and the piezoelectric component generates vibration to remove the foreign substances from the transparent cover, and a soft sealing material is used to surround the transparent cover to seal the optical sensing device. However, such a design using a soft sealing material (e.g., O-ring) as the interface between the vibration source (i.e., the piezoelectric component) and the surroundings has a competition contradiction between waterproof level and vibration ability. Specifically, if it is intended to improve the waterproof level of the optical detection system, a higher pressing amount for O-ring is required, which limits the vibration ability of the vibration source to the surroundings, thereby reducing the performance of foreign substance removal. On the contrary, if the pressing amount for O-ring is reduced for the purpose of increasing the vibration ability, moisture or even water will easily enter (leak into) the sealed space of the optical detection system. Therefore, the inventor has further proposed JP Patent No. 7281843 B2, which discloses an optical detection system ICVS (Instant Clear View System) and method that can automatically remove foreign objects, which uses a material with flexibility and rigidity to seal the optical sensing device, uses materials different from the prior art to seal the optical sensing device and transmit the vibration generated by the piezoelectric element, thereby enabling stable and effective automatic removal of foreign substances from the optical detection system.

However, even if the more optimized methods mentioned above are adopted to improve the transmission of the vibration from the vibration source, after removing foreign substances by vibration, the persisting small liquid droplets of the foreign substances are currently still an urgent problem to be solved. The conventional technology uses the heat energy generated by a vibration source such as lead zirconate titanate during high-frequency vibration to heat and vaporize the small liquid droplets on the observation window. However, high-frequency vibration represents high energy consumption. Meanwhile, for this type of vibration source, driving with high-frequency voltage will rapidly increase the temperature of the vibration source itself, and the heat accumulation under continuous high-temperature will lead to an adverse effect on the vibration ability of the vibration source. In severe cases, this may even lead to permanent depolarization and thus loss of vibration ability. In U.S. Pat. No. 11,366,076 B2, the operating temperature of the piezoelectric transducer is controlled by providing a temperature sensor and setting a temperature threshold, thereby achieving the effect of protecting the vibration source and maintaining its vibration ability. However, this method of protecting vibration sources also limits the efficiency of foreign substance removal, and is not suitable for applications that require rapid cleaning, such as optical detection systems in unmanned vehicles or driver assistance systems. Even for fixed optical monitoring systems, it is crucial to avoid the expansion of blind zone on the observation time axis as much as possible, so the practicality is greatly limited.

### SUMMARY OF THE INVENTION

In this regard, in view of the aforementioned optical sensing devices of optical detection systems with foreign object removal, the inventor has developed a heating enhanced structure for a photo-sensitive sensing device with automatic foreign object removal.

The present invention provides a heating enhanced structure for a photo-sensitive sensing device with automatic foreign object removal, wherein the enhanced comprises: a housing having an opening on one side thereof; a transparent protective cover disposed at the opening, the housing and the transparent protective cover together define an internal space of the photo-sensitive sensing device; a photo sensor disposed in the internal space of the photo-sensitive sensing device; a lens module provided between the transparent protective cover and the photo sensor; a piezoelectric element provided on an edge of the transparent protective cover in the internal space of the photo-sensitive sensing device; a sealing material with flexibility and rigidity, which has an annular flake shape, is provided between the edge of the transparent protective cover and an edge of the piezoelectric element, and extends and is fixed to the housing, thereby sealing the internal space of the photo-sensitive sensing device; and a heating element provided between a lateral side of the transparent protective cover and the sealing material; wherein the piezoelectric element performs vibration, and the vibration is transmitted to the transparent protective cover through the sealing material to remove foreign substances from the transparent protective cover, the heating element generates heat energy, and the heat energy is transmitted to the transparent protective cover through the sealing material to remove small liquid droplets from the transparent protective cover.

In another embodiment, the lens module is arranged at the opening, and the lens module includes: a top lens, which is the transparent protective cover of the photo-sensitive sensing device, and is disposed at an outermost side of the lens module with respect to the internal space of the photo-sensitive sensing device; a lateral casing, wherein the housing of the photo-sensitive sensing device further comprises the lateral casing, the top lens and the housing of the photo-sensitive sensing device including the lateral casing together define the internal space of the photo-sensitive sensing device; a bottom lens disposed on an opposite side of the top lens, and the top lens, the lateral casing and the bottom lens together define an interior space of the lens module; and one or more interior lens(es) disposed between the top lens and the bottom lens in the interior space of the lens module, wherein the heating element is provided between a lateral side of the top lens and the sealing material; wherein the piezoelectric element is provided on an edge of the top lens in the interior space of the lens module; the sealing material is provided between the edge of the top lens and the edge of the piezoelectric element, and extends and is fixed to the lateral casing, thereby sealing the internal space of the photo-sensitive sensing device; and wherein the piezoelectric element performs the vibration, and the vibration is transmitted to the top lens through the sealing material to remove the foreign substances from the top lens.

In a preferred embodiment, the photo-sensitive sensing device further includes a soft shielding material, which has an annular flake shape and is disposed on an outer side of the housing and an outer side of the transparent protective cover, thereby shielding a gap among the housing, the transparent protective cover, and the sealing material.

In a preferred embodiment, the enhanced structure further comprises a thermal insulation buffer element, which is disposed between the piezoelectric element and the sealing material, and is bond to the piezoelectric element and the sealing material, respectively.

In another preferred embodiment, the thermal insulation buffer element is disposed between the piezoelectric element and the heating material, and is bond to the heating material and the piezoelectric element, respectively.

### BRIEF DESCRIPTION OF THE DRAWINGS

FIG. 1 illustrates a heating enhanced structure for a photo-sensitive sensing device with automatic foreign object removal according to an embodiment of the present invention.

FIG. 2 illustrates a heating enhanced structure for a photo-sensitive sensing device with automatic foreign object removal according to another embodiment of the present invention.

FIG. 3 illustrates a heating enhanced structure for a photo-sensitive sensing device with automatic foreign object removal according to yet another embodiment of the present invention.

FIG. 4 illustrates a lens module of the heating enhanced structure for a photo-sensitive sensing device with automatic foreign object removal of FIG. 3 of the present invention.

FIG. 5A illustrates the bonding manner for a sealing material, a heating element and a piezoelectric element according to any embodiment of the present invention.

FIG. 5B illustrates the bonding manner for a sealing material, a heating element, a piezoelectric element, and the thermal insulation buffer element according to a preferred embodiment of the present invention.

FIG. 5C illustrates the bonding manner for a sealing material, a heating element, a piezoelectric element, and the thermal insulation buffer element according to another preferred embodiment of the present invention.

FIG. 5D illustrates the bonding manner for a sealing material, a heating element, a piezoelectric element, and the thermal insulation buffer element according to yet another preferred embodiment of the present invention.

### DETAILED DESCRIPTION OF THE PREFERRED EMBODIMENT

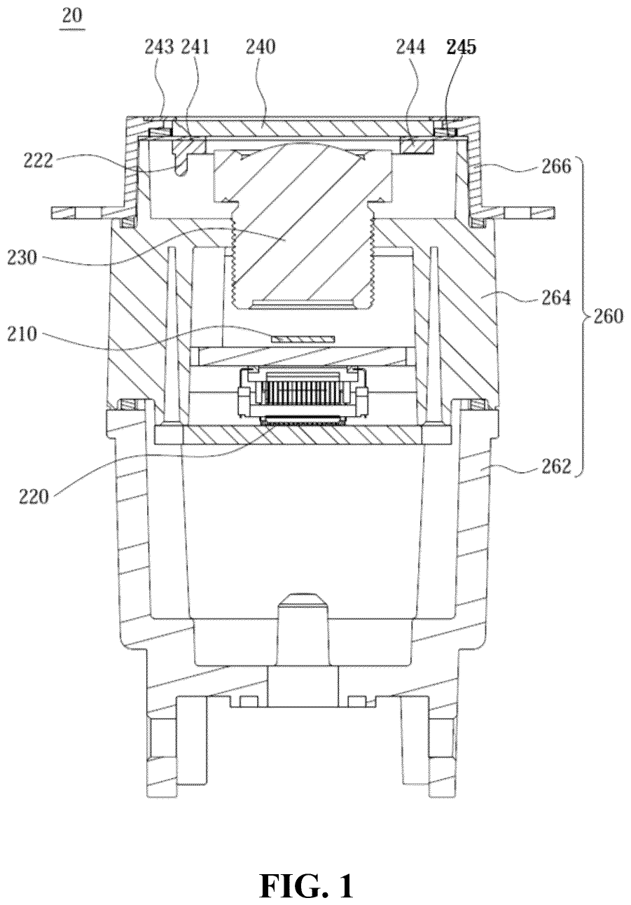

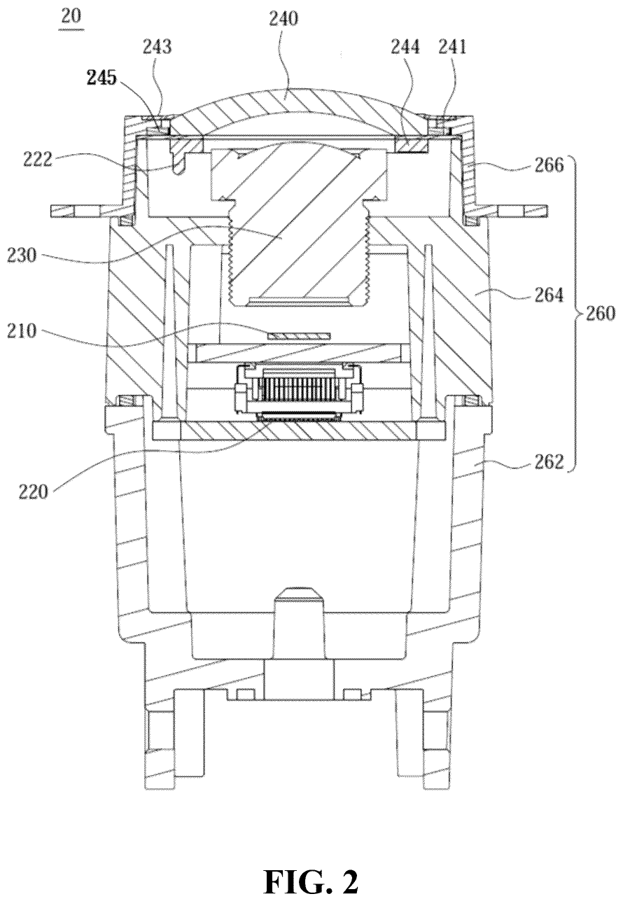

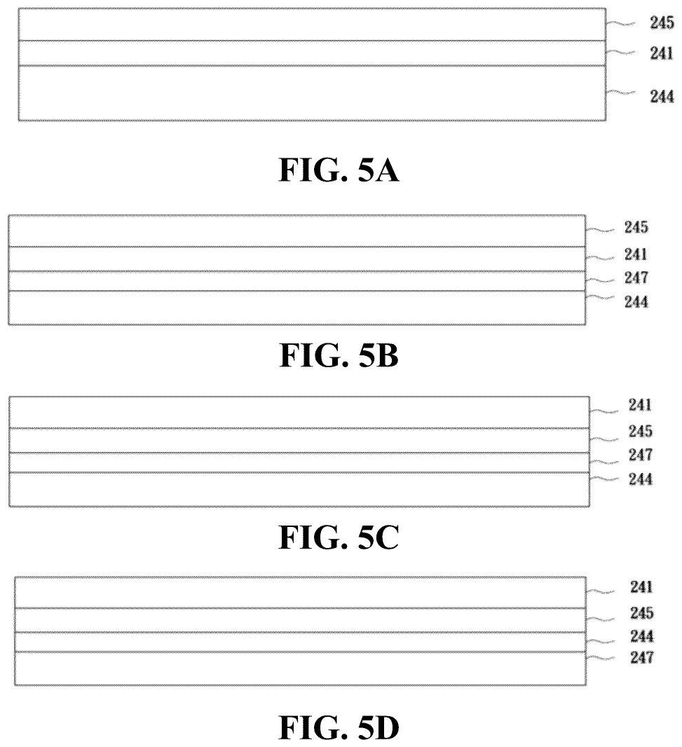

Hereinafter, structural details of the heating enhanced structure for a photo-sensitive sensing device with automatic foreign object removal according to the present invention are described with reference to the drawings, in which FIG. 1 illustrates an exemplary heating enhanced structure for a photo-sensitive sensing device with automatic foreign object removal of the present invention, and FIGS. 2 to 4 illustrate structural details of a photo-sensitive sensing device 20 in the photo-sensitive sensing devices with automatic foreign object removal according to various embodiments of the present invention. Since the following description focuses on the structural features, some elements described below with reference to FIGS. 5A, 5B and 5C may not be further described or illustrated in FIGS. 1 to 4. However, it can be understood that such elements can be integrated into the photo-sensitive sensing device (20 in FIGS. 2 to 4) and provided in the optical detection system 10 (not shown). The optical detection system 10 may be a photography system, and the photo-sensitive sensing device 20 may be a camera device, without being particularly limited thereto.

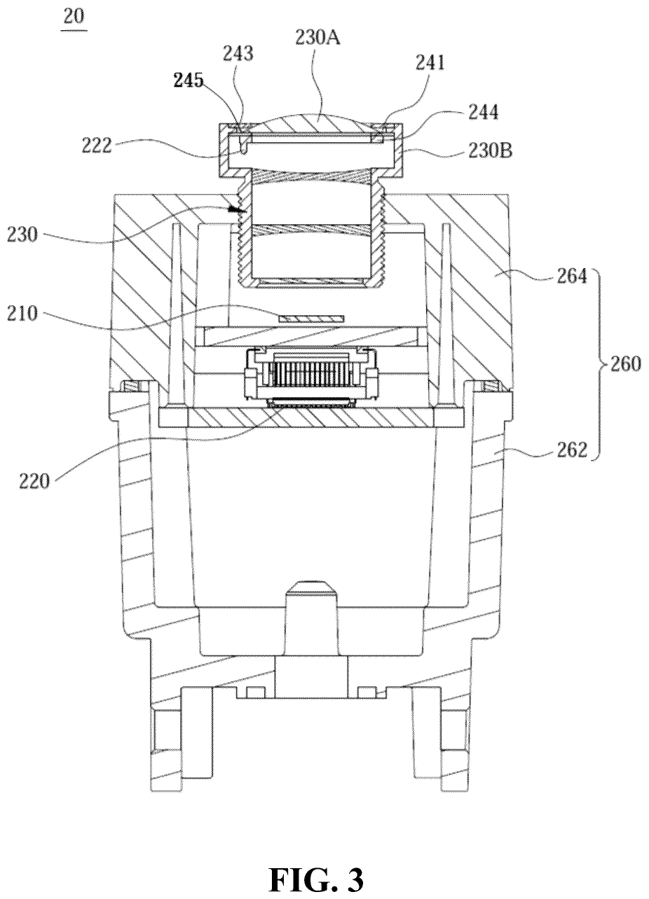

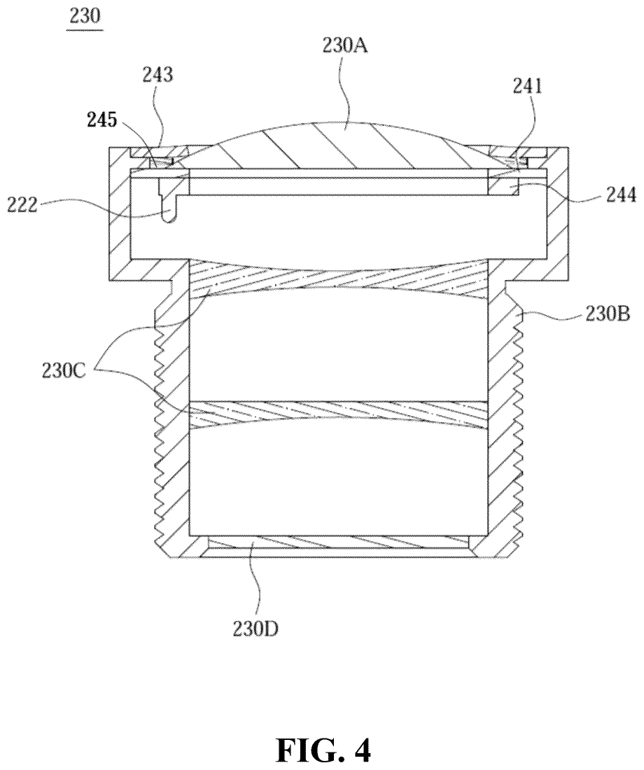

Referring to FIG. 1, the present invention provides a heating enhanced structure for a photo-sensitive sensing device with automatic foreign object removal. In the embodiment of the present invention, the photo-sensitive sensing device 20 includes: a housing 260; a transparent protective cover 240; a photo sensor 210; a lens module 230; a sealing material 241 with flexibility and rigidity; a piezoelectric element 244; and a heating element 245. FIG. 3 shows an embodiment in which the transparent protective cover 240 has a planner shape (e.g., a plane lens), and FIG. 4 shows an embodiment in which the transparent protective cover 240 has a curved shape (e.g., a convex lens or a concave lens).

The housing 260 has an opening at one side (e.g., upper side in FIGS. 3 and 4) thereof. The transparent protective cover 240 is disposed at the opening. The housing 260 and the transparent protective cover 240 together define an internal space of the photo-sensitive sensing device 20. A photo sensor 210 is disposed in the internal space of the photo-sensitive sensing device 20. The lens module 230 is provided between the transparent protective cover 240 and the photo sensor 210.

The piezoelectric element 244 is provided on an edge of the transparent protective cover 240 in the internal space of the photo-sensitive sensing device 20. The piezoelectric element 244 includes a piezoelectric material, such as PZT or the like. The piezoelectric element 244 may be electrically connected to a circuit board 220 via a cable 222. The sealing material 241 has an annular flake shape, which is provided (attached) between the edge of the transparent protective cover 240 and the edge of the piezoelectric element 244, and extends and is fixed to the housing 260, thereby sealing the internal space of the photo-sensitive sensing device 20. The piezoelectric element 244 performs vibration, and the vibration is transmitted to the transparent protective cover 240 through the sealing material 241 to remove foreign substances from the transparent protective cover 240.

Preferably, the piezoelectric element 244 may have an annular shape, and is arranged on the edge at the inner side of the transparent protective cover 240, allowing for removal of foreign substances in a more efficient and component-saving manner. The piezoelectric element 244 may be attached to the transparent protective cover 240. The piezoelectric element 244 may be disposed around a periphery of the lens module 230.

The sealing material 241 has flexibility and rigidity, and preferably includes one or more selected from a group consisting of aluminum, steel (e.g., SUS304), titanium alloy, magnesium aluminum alloy, polyimide (PI), polycarbonate (PC), and polyethylene terephthalate (PET). The sealing material 241 may be a metal foil of such as aluminum, steel, titanium alloy, or magnesium-aluminum alloy foil; or it may be a flake or film made of polyimide, polycarbonate, or polyethylene terephthalate. Preferably, the sealing material 241 has a thickness of 10 to 200 μm. The sealing material 241 is waterproof, and thus can seal the internal space of the photo-sensitive sensing device 20. The sealing material 241 with flexibility and rigidity can effectively transmit the vibration generated by the piezoelectric element 244 to the transparent protective cover 240 while reducing the vibration transmitted to other surroundings (except the transparent protective cover 240); moreover, the swing amplitude caused by vibration will not exceed the elongation. Therefore, as the interface between the vibration source and the surroundings, the sealing material 241 has sufficient support strength, without risk of breaking of the sealing material.

On the other hand, in the present invention, since the sealing material 241 with flexibility and rigidity is used instead of a soft sealing material of the prior art as the sealing material between the transparent protective cover 240 and the housing 260, a gap may exist among the housing 260, the transparent protective cover 240 and the sealing material 241. Therefore, the sealing material 241 may be exposed to the outside through such a gap, which may cause water or other substances to adhere to the sealing material 241. Therefore, in order to prevent water or other substances from adhering to the sealing material 241, a thin, soft material is used as a shielding material and attached onto the transparent protective cover 240 and the sealing material 241, thereby shielding such a gap, which can therefore prevent water or other substances from directly adhering to the sealing material 241. Therefore, in a preferred embodiment, the photo-sensitive sensing device 20 may further include a soft shielding material 243, which has an annular flake shape and is disposed on the outer side of the housing 260 and the outer side of the transparent protective cover 240, thereby shielding the gap among the housing 260, the transparent protective cover 240, and the sealing material 241.

Meanwhile, the heating element 245 is disposed between the transparent protective cover 240 and the sealing material 241. When small liquid droplets adhere to the transparent protective cover 240, the heating element 245 is activated independently to heat, thereby generating heat energy, and the heat energy is transmitted to the transparent protective cover 240 through the sealing material 241, or the transparent protective cover 240 is directly heated by contact heat conduction, so as to remove small liquid droplets.

According to some embodiments, the housing 260 may include a first housing 262, a lens module holder 264, and a second housing 266. A sealing member, such as an O-ring, may be provided between adjacent two of the first housing 262, the lens module holder 264 and the second housing 266 for sealing. In the embodiments shown in FIGS. 1 and 2, an opening of the housing 260 may be provided at the second housing 266 (especially at the upper side). In various embodiments of the present invention, the lens module 230 may be embedded in the photo-sensitive sensing device 20 (as shown in FIGS. 1 and 2), or the lens module 230 may at least partially protrude outward from the photo-sensitive sensing device 20 (as shown in FIG. 3).

Referring to FIG. 3, in another embodiment, the lens module 230 is disposed at the opening of the housing 260. In this case, the housing 260 includes only the first housing 262 and the lens module holder 264, with the opening of the housing 260 provided at the lens module holder 264 (especially at the upper side). Referring to FIG. 4, the lens module 230 may include a top lens 230A, a lateral casing 230B, one or more interior lens(es) 230C, and a bottom lens 230D. The top lens 230A, the interior lens 230C, and the bottom lens 230D may each have a planar surface or a curved surface, i.e., each of them may be a plane lens, a convex lens, or a concave lens.

Referring to FIG. 4, in this embodiment, the top lens 230A is the transparent protective cover 240 of the photo-sensitive sensing device 20, and is disposed at an outermost side of the lens module 230 with respect to the internal space of the photo-sensitive sensing device 20. The lateral casing 230B may be a barrel-shaped member, which, as a part of the housing 260 of the photo-sensitive sensing device 20, defines the internal space of the photo-sensitive sensing device 20 together with the top lens 230A and the housing 260. The bottom lens 230D is disposed on the side opposite to the top lens 230A. The top lens 230A, the lateral casing 230B and the bottom lens 230D together define the interior space of the lens module 230. The one or more interior lens(es) 230C is(are) disposed between the top lens 230A and the bottom lens 230D in the interior space of the lens module 230. In addition, in this embodiment, the piezoelectric element 244 is disposed at the edge of the top lens 230A in the interior space of the lens module 230. The sealing material 241 is provided (attached) between the edge of the top lens 230A and the edge of the piezoelectric element 244, and extends and is fixed to the lateral casing 230B, thereby sealing the internal space of the photo-sensitive sensing device 20. The piezoelectric element 244 performs vibration, and the vibration is transmitted to the top lens 230A through the sealing material 241 to remove foreign substances from the top lens 230A.

Meanwhile, the heating element 245 is disposed between the transparent protective cover 240 and the sealing material 241. When small liquid droplets adhere to the transparent protective cover 240, the heating element 245 is activated independently to heat, thereby generating heat energy, and the heat energy is transmitted to the transparent protective cover 240 or the top lens 230A through the sealing material 241, or the transparent protective cover 240 or the top lens 230A is directly heated by contact heat conduction, so as to remove small liquid droplets.

The photo-sensitive sensing device 20 may further include the circuit board 220 electrically connected to the photo sensor 210.

Referring to FIGS. 5A, 5B, 5C and 5D, in another preferred embodiment, a thermal insulation buffer element 247 may be added. In a combination without the thermal insulation buffer element 247, the heating element 245 is disposed on a side of the sealing material 241 relative to the piezoelectric element 244 to avoid heat conduction through directly contact from affecting the piezoelectric element 244. Preferably, in the case where the thermal insulation buffer element 247 is provided, the thermal insulation buffer element 247 can form combined arrangements as shown in FIGS. 5B, 5C or 5D, respectively. In FIG. 5B, the heating element 245 is disposed on one side of the sealing material 241 relative to the piezoelectric element 244, and the thermal insulation buffer element 247 is disposed between the sealing material 241 and the piezoelectric element 244 to achieve a better thermal insulation effect. Alternatively, as shown in FIG. 5C, the thermal insulation buffer element 247 can be disposed between the heating element 245 and the piezoelectric element 244, thereby blocking heat conduction through direct contact from affecting the piezoelectric element 244 by the thermal insulation buffer element 247. Alternatively, as shown in FIG. 5D, the thermal insulation buffer element 247 can be disposed below the piezoelectric element 244 to more effectively utilize the heat energy generated by the heating element 245, avoiding heat energy loss, thereby enabling a more rapid removal of small liquid droplets.

Any of the above attachments can be accomplished by glue adhesion, welding, or any other way, wherein the glue adhesion can be accomplished by using adhesives with good tensile characteristics and low hygroscopicity.

The piezoelectric element 244, the sealing material 241, the soft shielding material 243, the heating element 245, and the thermal insulation buffer element 247 can be arranged in any suitable annular shape, as long as they do not obstruct the incident light entering the photo sensor 210.

What is claimed is:

1. A heating enhanced structure for a photo-sensitive sensing device with automatic foreign object removal, comprising a photo-sensitive sensing device, wherein the photo-sensitive sensing device includes:
a housing having an opening on one side thereof;
a transparent protective cover disposed at the opening, the housing and the transparent protective cover together define an internal space of the photo-sensitive sensing device;
a photo sensor disposed in the internal space of the photo-sensitive sensing device;
a lens module provided between the transparent protective cover and the photo sensor;
a piezoelectric element provided on an edge of the transparent protective cover in the internal space of the photo-sensitive sensing device;
a sealing material with flexibility and rigidity, which has an annular flake shape, is provided between the edge of the transparent protective cover and an edge of the piezoelectric element, and extends and is fixed to the housing, thereby sealing the internal space of the photo-sensitive sensing device; and
a heating element provided between a lateral side of the transparent protective cover and the sealing material; wherein
the piezoelectric element performs vibration, and the vibration is transmitted to the transparent protective cover through the sealing material to remove foreign substances from the transparent protective cover, the heating element generates heat energy, and the heat energy is transmitted to the transparent protective cover through the sealing material to remove small liquid droplets from the transparent protective cover.

2. The heating enhanced structure for the photo-sensitive sensing device with automatic foreign object removal according to claim 1, wherein the heating element is provided between a lower side of the transparent protective cover and the sealing material.

3. The heating enhanced structure for the photo-sensitive sensing device with automatic foreign object removal according to claim 1, wherein the lens module is arranged at the opening, and the lens module includes:
a top lens, which is the transparent protective cover of the photo-sensitive sensing device, and is disposed at an outermost side of the lens module with respect to the internal space of the photo-sensitive sensing device;
a lateral casing, wherein the housing of the photo-sensitive sensing device further comprises the lateral casing, the top lens and the housing of the photo-sensitive sensing device including the lateral casing together define the internal space of the photo-sensitive sensing device;
a bottom lens disposed on an opposite side of the top lens, and the top lens, the lateral casing and the bottom lens together define an interior space of the lens module; and
one or more interior lens(es) disposed between the top lens and the bottom lens in the interior space of the lens module, wherein the heating element is provided between a lateral side of the top lens and the sealing material; wherein
the piezoelectric element is provided on an edge of the top lens in the interior space of the lens module;
the sealing material is provided between the edge of the top lens and the edge of the piezoelectric element, and extends and is fixed to the lateral casing, thereby sealing the internal space of the photo-sensitive sensing device; and wherein
the piezoelectric element performs the vibration, and the vibration is transmitted to the top lens through the sealing material to remove the foreign substances from the top lens,
the heating element generates the heat energy, and the heat energy is transmitted to the top lens through the sealing material to remove the small liquid droplets from the top lens.

4. The heating enhanced structure for the photo-sensitive sensing device with automatic foreign object removal according to claim 3, wherein the heating element is provided between a lower side of the top lens and the sealing material.

5. The heating enhanced structure for the photo-sensitive sensing device with automatic foreign object removal according to claim 1, wherein the photo-sensitive sensing device further includes a soft shielding material, which has an annular flake shape and is disposed on an outer side of the housing and an outer side of the transparent protective cover, thereby shielding a gap among the housing, the transparent protective cover, and the sealing material.

6. The heating enhanced structure for the photo-sensitive sensing device with automatic foreign object removal according to claim 2, wherein the photo-sensitive sensing device further includes a soft shielding material, which has an annular flake shape and is disposed on an outer side of the housing and an outer side of the transparent protective cover, thereby shielding a gap among the housing, the transparent protective cover, and the sealing material.

7. The heating enhanced structure for the photo-sensitive sensing device with automatic foreign object removal according to claim 3, wherein the photo-sensitive sensing device further includes a soft shielding material, which has an annular flake shape and is disposed on an outer side of the housing and an outer side of the transparent protective cover, thereby shielding a gap among the housing, the transparent protective cover, and the sealing material.

8. The heating enhanced structure for the photo-sensitive sensing device with automatic foreign object removal according to claim 4, wherein the photo-sensitive sensing device further includes a soft shielding material, which has an annular flake shape and is disposed on an outer side of the housing and an outer side of the transparent protective cover, thereby shielding a gap among the housing, the transparent protective cover, and the sealing material.

9. The heating enhanced structure for the photo-sensitive sensing device with automatic foreign object removal according to claim 1, wherein the heating enhanced structure further comprises a thermal insulation buffer element, which is disposed between the piezoelectric element and the sealing material, and is bond to the piezoelectric element and the sealing material, respectively.

10. The heating enhanced structure for the photo-sensitive sensing device with automatic foreign object removal according to claim 2, wherein the heating enhanced structure further comprises a thermal insulation buffer element, which is disposed between the piezoelectric element and the sealing material, and is bond to the piezoelectric element and the sealing material, respectively.

11. The heating enhanced structure for the photo-sensitive sensing device with automatic foreign object removal according to claim 3, wherein the heating enhanced structure further comprises a thermal insulation buffer element, which is disposed between the piezoelectric element and the sealing material, and is bond to the piezoelectric element and the sealing material, respectively.

12. The heating enhanced structure for the photo-sensitive sensing device with automatic foreign object removal according to claim 4, wherein the heating enhanced structure further comprises a thermal insulation buffer element, which is disposed between the piezoelectric element and the sealing material, and is bond to the piezoelectric element and the sealing material, respectively.

13. The heating enhanced structure for the photo-sensitive sensing device with automatic foreign object removal according to claim 1, wherein the heating enhanced structure further comprises a thermal insulation buffer element, which is disposed between the piezoelectric element and the heating material, and is bond to the heating material and the piezoelectric element, respectively.

14. The heating enhanced structure for the photo-sensitive sensing device with automatic foreign object removal according to claim 2, wherein the heating enhanced structure further comprises a thermal insulation buffer element, which is disposed between the piezoelectric element and the heating material, and is bond to the heating material and the piezoelectric element, respectively.

15. The heating enhanced structure for the photo-sensitive sensing device with automatic foreign object removal according to claim 3, wherein the heating enhanced structure further comprises a thermal insulation buffer element, which is disposed between the piezoelectric element and the heating material, and is bond to the heating material and the piezoelectric element, respectively.

16. The heating enhanced structure for the photo-sensitive sensing device with automatic foreign object removal according to claim 4, wherein the heating enhanced structure further comprises a thermal insulation buffer element, which is disposed between the piezoelectric element and the heating material, and is bond to the heating material and the piezoelectric element, respectively.

17. The heating enhanced structure for the photo-sensitive sensing device with automatic foreign object removal according to claim 1, wherein the heating enhanced structure further comprises a thermal insulation buffer element, which is disposed below the piezoelectric element, and is bond to the piezoelectric element.

18. The heating enhanced structure for the photo-sensitive sensing device with automatic foreign object removal according to claim 2, wherein the heating enhanced structure further comprises a thermal insulation buffer element, which is disposed below the piezoelectric element, and is bond to the piezoelectric element.

19. The heating enhanced structure for the photo-sensitive sensing device with automatic foreign object removal according to claim 3, wherein the heating enhanced structure further comprises a thermal insulation buffer element, which is disposed below the piezoelectric element, and is bond to the piezoelectric element.

20. The heating enhanced structure for the photo-sensitive sensing device with automatic foreign object removal according to claim 4, wherein the heating enhanced structure further comprises a thermal insulation buffer element, which is disposed below the piezoelectric element, and is bond to the piezoelectric element.
